(19) United States
(12) Patent Application Publication
(10) Pub. No.: US 2025/0120398 A1
(43) Pub. Date: Apr. 17, 2025

(54) COMPOSITIONS FOR ENHANCING PESTICIDES

(71) Applicant: TERRAMERA, INC., Vancouver (CA)

(72) Inventors: Annett ROZEK, Port Moody (CA); Hangsheng LI, Vancouver (CA); Richel Sze Heng POON, Vancouver (CA)

(21) Appl. No.: 18/696,000

(22) PCT Filed: Sep. 27, 2022
(86) PCT No.: PCT/CA2022/051430

§ 371 Date: Mar. 27, 2024

Related U.S. Application Data
(60) Provisional application No. 63/248,949, filed on Sep. 27, 2021.

(51) Int. Cl. A01N 37/02; A01N 25/04; A01N 57/12; A01N 59/00

(52) U.S. Cl. CPC A01N 37/02; A01N 25/04; A01N 57/12; A01N 59/00

(57) ABSTRACT

A salt formed by mixing one or more aliphatic acids with a volatile base may be combined with a pesticidal composition (and/or, in some cases, an adjuvant for a pesticidal composition). Adding the volatile base can improve solubility of the one or more aliphatic acids in at least some pesticidal compositions and/or adjuvants, better promote a target pH of the resulting pesticidal composition, and/or promote bioactivity of the one or more aliphatic acids post-application. The composition can be applied together with a pesticide, e.g. by spraying, to control plant pests.

### CROSS-REFERENCE TO RELATED APPLICATIONS

This application claims priority to, and the benefit of, U.S. provisional patent application No. 63/248,949 filed 27 Sep. 2021 and entitled COMPOSITIONS FOR ENHANCING PESTICIDES. The foregoing application is incorporated by reference herein in its entirety.

### TECHNICAL FIELD

The present disclosure relates generally to pesticidal compositions, and particularly to compositions for enhancing physical characteristics of pesticidal compositions, such as those related to the storage, mixing, transportation, application, and/or efficacy of the pesticidal composition in, e.g., agricultural, horticultural or household pest control contexts.

### BACKGROUND

Pesticides, including fungicides, herbicides, nematicides and insecticides, are important compositions for use in domestic, agricultural, industrial and commercial settings, such as to provide for control of unwanted pests and/or pathogens. Pesticidal compositions can be mixed with further ingredients prior to application, such as solvents, carriers, and/or adjuvants (e.g. activators, spreaders, stickers, emulsifiers, penetrants, etc.), e.g. to affect the physical characteristics of the resulting formulation.

Pesticidal applications generally have various requirements to maintain utility, which may be found on the label(s) of the compositions being applied (e.g. pesticidal compositions, adjuvants, etc.) and/or may be desired due to the nature of the application. For example, for a particular application there may be requirements such as approved pH ranges, dilution concentrations, and the like. Such requirements may be imposed to achieve ends such as regulatory compliance, pesticidal efficacy, the avoidance of precipitation of ingredients during application, ensuring that droplets of the pesticidal composition achieve certain levels of drift, spread, or stick, and the like. To stay within the ambit of such requirements, adjuvants for combination with such pesticidal compositions are often specially-formulated for specific pesticides and/or may need to be mixed in different specific mixture ratios with different pesticides. Adding further ingredients to mixtures of pesticides and adjuvants can compound these challenges substantially.

A variety of compositions have recently been discovered to provide synergistic efficacy with certain pesticidal compositions (see, e.g., PCT Application No. PCT/IB2018/057597). There is a general desire to combine such synergistic compositions with pesticides while maintaining certain chemical requirements, and there is particularly a desire to combine such synergistic compositions with mixtures of pesticides and adjuvants.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the disclosure provides a composition for combination with a pesticidal composition including at least one pesticidal active ingredient. The composition comprises one or more aliphatic acids and a volatile base. The one or more aliphatic acids and the volatile base are neutralizable to form a salt, and the salt is at least one of soluble and emulsifiable with at least one of the pesticidal composition and an adjuvant for the pesticidal composition to form a combined pesticidal composition.

In some embodiments, the composition comprises a homogeneous mixture of the salt and the adjuvant. In some embodiments, the composition comprises a homogeneous mixture of the salt, the adjuvant, and pesticidal composition. In some embodiments, the composition comprises a homogeneous mixture of: the one or more aliphatic acids comprising about 20 to 50 wt %; the volatile base comprising about 10 to 30 wt %; and the adjuvant comprising about 40 to 60 wt %. In some embodiments, the composition comprises a mixture ratio of one or more aliphatic acids to adjuvant of at least about 2:5 w/w. In some embodiments, the mixture ratio of one or more aliphatic acids to adjuvant is at most about 1:1 w/w. In some embodiments, the composition comprises a mixture ratio of one or more aliphatic acids to volatile base in a range of about 25:18 to 25:12, or about 3:2 to 2:1.

In some embodiments, the adjuvant comprises a liquid fatty acid and the liquid fatty acid comprises 10 to 100 wt % of the adjuvant. In some embodiments, the liquid fatty acid comprises propionic acid and the propionic acid comprises 30 to 40 wt % of the adjuvant. In some embodiments, the adjuvant comprises a phospholipid and the phospholipid comprises 10 to 100 wt % of the adjuvant. In some embodiments, the phospholipid comprises a soyal phospholipid and the soyal phospholipid comprises 30 to 40 wt % of the adjuvant. In some embodiments, the adjuvant has a pH in a range of about 1 to 6. In some embodiments, the adjuvant has a pH in a range of about 3 to 4.

In some embodiments, the one or more aliphatic acids comprises a saturated or unsaturated fatty acid. In some embodiments, the fatty acid has a carbon chain length no greater than 12. In some embodiments, the fatty acid comprises at least one of: a trans-unsaturated C—C bond, a cis-unsaturated C—C bond, and a plurality of conjugated unsaturated C—C bonds. In some embodiments, the fatty acid comprises at least one of: a trans-2, trans-3, trans-4, trans-5, trans-6, trans-7, trans-8, trans-9, trans-10, trans-11, cis-2, cis-3, cis-4, cis-5, cis-6, cis-7, cis-8, and cis-9, cis-10, and cis-11 unsaturated bond. In some embodiments, the fatty acid comprises at least one of a trans-hexenoic acid, a cis-hexenoic acid, a hexa dienoic acid, a hexynoic acid, a trans heptenoic acid, a cis heptenoic acid, a hepta dienoic acid, a heptynoic acid, a trans octenoic acid, a cis octenoic acid, an octa dienoic acid, an octynoic acid, a trans nonenoic acid, a cis nonenoic acid, a nona dienoic acid, a nonynoic acid, a trans decenoic acid, a cis decenoic acid, a deca dienoic acid, a decynoic acid, a trans dodecenoic acid, a cis dodecenoic acid, a dodeca dienoic acid, a dodecynoic acid, hexanoic acid, heptanoic acid, octanoic acid, nonanoic acid, decanoic acid, and dodecanoic acid. In some embodiments, the fatty acid is selected from the group consisting of: octanoic acid and decanoic acid. In some embodiments, the one or more aliphatic acids comprise a mixture of octanoic acid and decanoic acid.

In some embodiments, the volatile base comprises ammonium hydroxide.

In some embodiments, the pesticidal composition has an effective pH range, an acidified mixture of the one or more aliphatic acids and the pesticidal composition would have a pH outside the effective pH range, and the volatile base is effective to increase the pH of the acidified mixture to within about the effective pH range. In some embodiments, an adjuvant-pesticide mixture of the pesticidal composition and the adjuvant would have an effective pH range, an acidified mixture of the one or more aliphatic acids and the adjuvant-pesticide mixture would have a pH outside the effective pH range, and the volatile base is effective to increase the pH of the acidified mixture to within about the effective pH range. In some embodiments, the volatile base is effective to increase the pH of the acidified mixture to at least about 5. In some embodiments, the pesticidal active ingredient comprises a spinosyn compound. In some embodiments, the pesticidal composition has a label pH range with a minimum value of about 6.

Another aspect of the present disclosure provides a method for making the compositions described above and elsewhere herein. The method comprises mixing one or more aliphatic acids and a volatile base to form a salt thereof. The salt is at least one of soluble and emulsifiable with at least one of the pesticidal composition and an adjuvant for the pesticidal composition to form a combined pesticidal composition. In some embodiments, the method comprises mixing the adjuvant for the pesticidal composition with at least one of the one or more aliphatic acids and the volatile base. In some embodiments, mixing the adjuvant for the pesticidal composition with at least one of the one or more aliphatic acids and the volatile base comprises mixing the one or more aliphatic acids, the volatile base, and the adjuvant to form a homogeneous mixture of: the one or more aliphatic acids comprising about 20 to 50 wt %; the volatile base comprising about 10 to 30 wt %; and the adjuvant comprising about 40 to 60 wt %.

In some embodiments, the method comprises mixing the one or more aliphatic acids, the volatile base, and the adjuvant with the pesticidal composition to form the combined pesticidal composition. In some embodiments, the salt is at least one of soluble and emulsifiable with the adjuvant to form a salt-adjuvant composition and mixing the one or more aliphatic acids, the volatile base, and the adjuvant with the pesticidal composition comprises mixing the adjuvant with the salt to form a salt-adjuvant composition. The method may further comprise mixing the salt-adjuvant composition with the pesticidal composition to form the combined pesticidal composition. In some embodiments, mixing the one or more aliphatic acids, the volatile base, and the adjuvant with the pesticidal composition comprises mixing the volatile base with the adjuvant to form a base-adjuvant composition and mixing the one or more aliphatic acids with the base-adjuvant composition, the pesticidal composition, and/or a mixture thereof.

Aspects of the present disclosure provide a method for applying a pesticidal composition to control at least one plant pest. The method comprises making a combined pesticidal composition comprising an aliphatic acid, a volatile base, and a pesticidal composition, wherein making the combined pesticidal composition comprises making a composition for combination with the pesticidal composition as described above and elsewhere herein. The method further comprises applying the combined pesticidal composition to at least one plant, the locus thereof, or propagation material thereof, which is susceptible to or infested with the at least one plant pest; and causing, by the applying, the volatile base to evaporate, thereby reconstituting the aliphatic acid on the at least one plant, the locus thereof, or propagation material thereof.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A shows an example preparation process for preparing an example composition wherein aliphatic acids and a volatile base are mixed together to form a salt before combination with an adjuvant or pesticidal composition.

FIG. 1B shows an example preparation process for preparing an example composition wherein aliphatic acids are mixed with an adjuvant before mixing with a volatile base to form a salt in the presence of the adjuvant.

FIG. 2A is a photograph of an example mixture of aliphatic acids, a volatile base, and an adjuvant in stoke solution form wherein the stoke solution exhibits foaming.

FIG. 2B is a photograph of an example mixture of aliphatic acids, a volatile base, and an adjuvant in diluted form wherein the dilution is clear and stable.

FIG. 2C is a photograph of an example mixture of aliphatic acids, a volatile base, and an adjuvant in stoke solution form wherein the stoke solution exhibits significant viscosity and crash-out of the aliphatic acids.

### DESCRIPTION

### Introductory Generalities

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable methods and materials are described herein.

All applications, publications, patents and other references, citations cited herein are incorporated by reference in their entirety. In case of conflict, the specification, including definitions, will control.

As used herein, the singular forms “a”, “and,” and “the” include plural referents unless the context clearly indicates otherwise.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

As used herein, “plant” embraces individual plants or plant varieties of any type of plants, in particular agricultural, silvicultural and ornamental plants.

As used herein, the terms “pest” or “pests” or grammatical equivalents thereof, are understood to refer to organisms, e.g., including pathogens, that negatively affect a host or other organism—such as a plant or an animal—by colonizing, damaging, attacking, competing with them for nutrients, infesting or infecting them, as well as undesired organisms that infest human structures, dwellings, living spaces or foodstuffs. Pests include but are not limited to fungi, weeds, nematodes, acari, and arthropods, including insects, arachnids and cockroaches. It is understood that the terms “pest” or “pests” or grammatical equivalents thereof can refer to organisms that have negative effects by infesting plants and seeds, and commodities such as stored grain.

As used herein, the terms “pesticide” or “pesticidal” or grammatical equivalents thereof, are understood to refer to any composition or substance that can be used in the control of any agricultural, natural environmental, and domestic/household pests. The terms “control” or “controlling” are meant to include, but are not limited to, any killing, inhibiting, growth regulating, or pestistatic (inhibiting or otherwise interfering with the normal life cycle of the pest) activities of a composition against a given pest. These terms include for example sterilizing activities which prevent the production or normal development of seeds, ova, sperm or spores, cause death of seeds, sperm, ova or spores, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, interfering with mycelial growth, reducing gut motility, inhibiting the formation of chitin, disrupting mating or sexual communication, preventing feeding (antifeedant) activity, and interfering with location of hosts, mates or nutrient-sources. The term “pesticide” includes fungicides, herbicides, nematicides, arthropodicides (e.g. insecticides, arachnicides, acaricides, aphicides, etc.) and the like. The term “pesticide” encompasses, but is not limited to, naturally occurring compounds as well as so-called “synthetic chemical pesticides” having structures or formulations that are not naturally occurring, where pesticides may be obtained by various means including, but not limited to, extraction from biological sources, chemical synthesis of the compound, and chemical modification of naturally occurring compounds obtained from biological sources.

As used herein, the terms “control” or “controlling” or grammatical equivalents thereof, are understood to encompass any pesticidal (killing) activities or pestistatic (inhibiting, repelling, deterring, and generally interfering with pest functions to prevent the damage to the host plant) activities of a pesticidal composition against a given pest. Thus, the terms “control” or “controlling” or grammatical equivalents thereof, not only include killing, but also include such activities as repelling, deterring, inhibiting or killing egg development or hatching, inhibiting maturation or development, and chemisterilization of larvae or adults. Repellant or deterrent activities may be the result of compounds that are poisonous, mildly toxic, or non-poisonous to pests, or may act as pheromones in the environment.

As used herein, the term “pesticidally effective amount” generally means the amount of the inventive mixtures or of compositions comprising the mixtures needed to achieve an observable effect on growth, including the effects of necrosis, death, retardation, prevention, and removal, destruction, or otherwise diminishing the occurrence and activity of the target pest organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

As used herein, the terms “eutectic” (and related terms such as “eutectic mixture”) generally refer to homogeneous mixtures of two or more ingredients where the melting point of the mixture is less than the melting points of each of the two or more ingredients. The mixture may be a constituent of another mixture, and thus may itself be mixed with other ingredients (which may have melting points above or below the melting point of the eutectic mixture) and still be considered eutectic for the purposes of this disclosure and the appended claims. Otherwise put, the eutectic mixture may optionally comprise further ingredients which do not necessarily contribute to the eutectic relationship of the two or more ingredients without diverging from the meaning of “eutectic” as used herein. The melting point of the mixture is not necessarily the lowest possible melting point achieved by an optimal mixture ratio of the two or more ingredients (sometimes called the “eutectic point”); although such mixtures are encompassed by the meaning of “eutectic” as used herein, any mixture with ingredients capable of forming a eutectic system and which has a melting point less than the melting points of two or more ingredients is “eutectic” for the purposes of this disclosure and the appended claims. In one aspect, the melting point of such a mixture may alternatively or in addition comprise a eutectic viscosity transition point, and the eutectic viscosity transition point may be less than the corresponding viscosity transition points of two or more of the ingredients of the mixture.

As used herein, where a range of values is provided, it is understood that each intervening value, to the tenth of the unit of the lower limit unless the context clearly dictates otherwise, between the upper and lower limit of that range and any other stated or intervening value within that stated range is encompassed within embodiments of the invention. The upper and lower limits of these smaller ranges may independently define a smaller range of values, and it is to be understood that these smaller ranges are intended to be encompassed within embodiments of the invention, subject to any specifically excluded limit in the stated range.

Compositions for Combination with Pesticidal Compositions

In some aspects of the present invention, novel compositions for combination with pesticidal compositions, and methods for making them, are disclosed. In at least some embodiments the composition comprises a salt formed by mixing one or more aliphatic acids with a volatile base. The composition may optionally be mixed with an adjuvant, and/or may optionally be mixed with the pesticidal composition (that is, the presently-disclosed compositions include formulations both with and without an adjuvant and/or pesticidal composition). As described in greater detail herein, such compositions can have improved solubility (relative to adding one or more aliphatic acids without the volatile base), can help to maintain a target pH of the resulting pesticidal composition, and/or can promote bioactivity of the one or more aliphatic acids post-application.

Combining an aliphatic acid (or more than one aliphatic acid) with a pesticidal composition can be advantageous. For example, combining certain aliphatic acids with a pesticidal composition may provide synergistic efficacy (see, e.g., PCT Application Nos. PCT/CA2019/051896 and PCT/CA2019/051897, incorporated herein by reference). However, there are several challenges when producing a mixture of one or more aliphatic acids and a pesticidal composition with the desired characteristics (e.g. pesticidal efficacy, chemical stability, phase, etc.).

One potential challenge is that mixing one or more aliphatic acids with a pesticidal composition may affect the mixture's pH, e.g. by lowering the mixture's pH too far outside of the pesticidal composition's label range and/or by making the mixture more acidic than is desired for a particular application (e.g. an agricultural application). Another potential challenge is that aliphatic acids may precipitate at relatively lower concentrations in the pesticidal composition than are desired (e.g. due to low solubility, emulsifiability, etc.), which can inhibit application of the composition.

Further challenges may arise if the pesticidal composition is to be mixed with an adjuvant as well as one or more aliphatic acids. The adjuvant is likely already precisely formulated for combination with the pesticidal composition and may comprise an array of suitable solvents, carriers, wetters, spreaders, penetrants, stickers, emulsifiers, activators, nutrients, retardants, stimulants, binders, and/or the like. Even if it is feasible to prepare a formulation for the aliphatic acid which addresses the foregoing challenges when mixed with the pesticidal composition (e.g. by mixing the one or more aliphatic acids with suitable carriers, solvents, emulsifiers, etc.), that formulation may interfere with the activity of the adjuvant and/or may provide superfluous ingredients in view of the adjuvant's ingredients.

Yet more challenges may arise if the aliphatic acids are mixed with the adjuvant prior to mixing the combined acid-adjuvant mixture with the pesticide. Such a mixing process may be used, for example, in circumstances where a single composition is to be mixed with the pesticide (e.g. as a so-called “tank mix”). Low solubility of the one or more aliphatic acids in the adjuvant or some other chemical incompatibility between the one or more aliphatic acids and the adjuvant may hinder the preparation of an acid-adjuvant composition with the desired characteristics; for example, the concentration of the aliphatic acid may need to be lower than desired in order to maintain homogeneity of the mixture. Such challenges can arise even if the one or more aliphatic acids are adequately soluble/emulsifiable with the pesticidal composition, as the interaction between aliphatic acid and adjuvant can differ from that between aliphatic acid and pesticidal composition.

In some embodiments, the one or more aliphatic acids are mixed with a base (such as sodium hydroxide) to form a salt. The base may be added in sufficient quantity to adjust the pH of the final mixture of pesticidal composition, one or more aliphatic acids, base, and optional adjuvant (referred to herein as the “combined pesticidal composition”) to within a target pH range (described in greater detail below). In at least some circumstances, such as where the adjuvant (and/or pesticidal composition, as applicable) is acidic, the resulting salt tends to have greater solubility than the one or more aliphatic acids alone. Without being bound by any particular theory, this may be attributable to the acid of the adjuvant (and/or pesticidal composition, as applicable) acting to dissolve the salt.

In some embodiments, the target pH range comprises the label range for the pesticidal composition, adjuvant, one or more aliphatic acids, and/or any other composition in the mixture. In some embodiments, the target pH range is a range of pH values which differ from such a label range by at most a threshold amount (e.g. for a pesticidal composition with a pH range of 6-8, the target range could comprise pH values which differ from that range by at most 1, i.e. a range of 5-9). In some embodiments, the target pH range comprises a range of pH values in which the one or more aliphatic acids provide a target measure of synergistic efficacy with the pesticidal composition; for example, the one or more aliphatic acids may provide a greater degree of synergistic efficacy at an acidic pH, so the target pH range may comprise sufficiently acidic pH values (e.g. pH values at or below 5, 6, and/or 7). In some embodiments, the target pH range comprises an intersection of one or more of the foregoing. For example, for a pesticidal composition with a pH range of 6-8 and an aliphatic acid which provides a stronger measure of synergistic efficacy with the pesticidal composition in an acidic pH range, the target pH range may comprise a pH range of 5-7, 5-6, 6-7, and/or subranges thereof.

Still more challenges can arise from the addition of a base. For at least some aliphatic acids (such as the fatty acids described in PCT Application No. PCT/CA2019/051896), the anionic salt form has decreased bioactivity relative to the aliphatic acid form. As more base is added and the resulting mixture's pH increases, the effective concentration of bioactive aliphatic acid decreases. The combined pesticidal composition will thus tend to not achieve the level of pesticidal efficacy which one might expect based on the quantity of aliphatic acid in the final mixture.

In some embodiments, the base comprises a volatile base, such as ammonium hydroxide and/or trimethylamine. In at least some embodiments, at least one of the volatile base and the salt produced by the one or more aliphatic acids and the volatile base is agriculturally compatible (e.g. non-toxic, registered for use by licensing authorities, and/or otherwise suitable for agricultural application). The volatile base promotes a pH in the target pH range of the mixture in the storage vessel (such as a bottle or spray tank), as described above. After application to a plant and/or pest the volatile base will at least partially undergo volatilization and evaporate, e.g. after a sprayed formulation of the combined pesticidal composition dries. Such volatilization converts (at least some) of the one or more aliphatic acids from an anionic salt form to an acid form, thus restoring the bioactivity of the one or more aliphatic acids. Although the aliphatic acids may at this stage precipitate (especially if, for example, the combined pesticidal composition is sprayed and subsequently dries on the plant and/or pest), this is not necessarily a problem post-application since homogeneity is usually principally desired to assist in application.

In at least some embodiments, the composition comprises the salt combined with the adjuvant (e.g. by mixing the one or more aliphatic acids and the volatile base with the adjuvant). Each combination of aliphatic acid(s) and adjuvant will have an associated threshold mixture ratio (of acid(s) to adjuvant) above which the one or more aliphatic acids will at least partially precipitate, at least under typical conditions. For example, experimental results (discussed in greater detail below) show that a mixture of octanoic acid and decanoic acid (with a 2:3 mixture ratio), when mixed with LI-700®, begin to precipitate at a mixture ratio of about 2:5 w/w. LI-700® is a commercial adjuvant comprising propionic acid and soy lecithin. By mixing in a volatile base such as ammonium hydroxide (e.g. as described above), acid:adjuvant mixture ratios of up to 1:1 w/w have been observed which maintain homogeneity. Mixture ratios of acid to base of about 25:12 w/w or less (e.g. as low as about 25:18 w/w) have been observed to allow for acid:adjuvant mixture ratios of 1:1 w/w, at least for the tested compositions. Mixture ratios of acid to base greater than 25:12 w/w have been observed to enable acid:adjuvant mixture ratios still in excess of the observed natural precipitation threshold of 2:5 w/w while maintaining homogeneity. In some embodiments, the mixture ratio of the one or more aliphatic acids and volatile base is at most 1:1 in molar terms (i.e. equal molar quantities of the aliphatic acid(s) and volatile base). In some embodiments, acid:base mixture ratios in the range of about 3:2 to 2:1 are preferred. In some embodiments, the composition comprises an acid:base mixture ratio in the range of about 3:2 to 2:1 and an acid:adjuvant mixture ratio in the range of about 2:5 w/w to about 1:1 w/w, and in particular may comprise an acid:adjuvant mixture ratio of about 1:1 w/w.

In some embodiments, the adjuvant is acidic—e.g. having a pH in a range from 1 to 6. In some embodiments, the adjuvant comprises a liquid fatty acid (e.g. a short-chain fatty acid, such as those having carbon chain length of 9 or lower) as a significant ingredient—e.g. comprising 10-100 wt % of the adjuvant. Without being bound to any particular theory, it is believed that the acid component of the adjuvant can contribute to dissolving the salt formed from the one or more aliphatic acids and the volatile base, thereby promoting homogeneity of the salt-adjuvant mixture and/or the combined pesticidal composition. In some embodiments, such as those comprising LI-700®, the adjuvant has a pH in the range from 3 to 4. In some embodiments, such as those comprising LI-700®, the adjuvant comprises propionic acid comprising 30-40 wt % of the adjuvant.

In some embodiments, the adjuvant comprises a phospholipid (e.g. a soyal phospholipid) as a significant ingredient—e.g. comprising 10-100 wt % of the adjuvant. For example, in some embodiments, such as those comprising LI-700®, the adjuvant comprises soy lechithin, a soyal phospholipid, comprising 30-40 wt % of the adjuvant. Without being bound by any particular theory, it is believed that adjuvants which are formulated to form homogeneous mixtures with phospholipid (such as a soyal phospholipid) ingredients will tend to homogenously mix with compositions which are chemically similar to such phospholipid ingredients. Ammonium salts of fatty acids, for instance, are generally chemically similar to soy lecithin, which may at least partially explain the superior solubility of salts of octanoic acid, decanoic acid, and ammonium hydroxide in LI-700® relative to mixtures of LI-700® with the acids alone.

In some embodiments, the one or more aliphatic acids comprise saturated and/or unsaturated aliphatic acids (also known as fatty acids). In some embodiments, the one or more aliphatic acids have carbon chain lengths no greater than 12 carbon atoms. For example, the aliphatic acid may comprise a C6-C12 fatty acid. As another example, the aliphatic acid may comprise a C6-C10 fatty acid. In some embodiments, the aliphatic acid comprises a naturally occurring aliphatic acid, such as may be present in, or extracted, fractionated or derived from a natural plant or animal material. For example, the aliphatic acid may comprise one or more naturally occurring aliphatic acids provided in a plant extract or fraction thereof. As another example, the aliphatic acid may comprise one or more naturally occurring aliphatic acids provided in an animal extract or product, or fraction thereof. In some embodiments, the aliphatic acid may comprise a naturally occurring aliphatic acid comprised in a plant oil extract, such as one or more of coconut oil, palm oil, palm kernel oil, corn oil, or fractions or extracts therefrom. In some such embodiments, the aliphatic acid may comprise a naturally occurring aliphatic acid comprised in an animal extract or product, such as one or more of cow's milk, goat's milk, beef tallow, and/or cow or goat butter, or fractions or extracts therefrom. In at least one embodiment, the aliphatic acid is provided as a component of one or more natural plant or animal material, or extract or fraction thereof. In at least one embodiment, the aliphatic acid is provided in an extract or fraction of one or more plant oil extract, such as one or more of coconut oil, palm oil, palm kernel oil, corn oil, or fractions or extracts therefrom.

The aliphatic acid may comprise cis or trans isomers, may be saturated or unsaturated, may comprise branched or unbranched carbon chains, and/or may comprise any combination thereof (including combinations of different aliphatic acids, e.g. in mixture). For example, unsaturated aliphatic acids may comprise at least one of: a trans-unsaturated C—C bond, a cis-unsaturated C—C bond, and/or a plurality of conjugated unsaturated C—C bonds. As another example the unsaturated aliphatic acids may comprise one or more of a trans-2, trans-3, trans-4, trans-5, trans-6, trans-7, trans-8, trans-9, trans-10, trans-11, cis-2, cis-3, cis-4, cis-5, cis-6, cis-7, cis-8, cis-9, cis-10, and cis-11 unsaturated bond (e.g. hexanoic acid, octanoic acid, decanoic acid, and/or oleic acid).

In some embodiments, the one or more aliphatic acids comprise a mixture of aliphatic acids. As described, for example, in PCT Application No. PCT/CA2019/051896, various aliphatic acids can each provide synergistic efficacy when combined with certain pesticidal compositions, and the degree of efficacy when applied in combination against certain pesticides and when controlling certain pests can vary between aliphatic acids. A combination of the two can provide a broader-spectrum synergistic efficacy (e.g. across more pesticides, across more pests, and/or greater efficacy against certain pests). For example, octanoic acid and decanoic acid can each provide synergistic efficacy when combined with certain pesticidal compositions, such as those comprising spinosyns, when applied to control certain pests. A combination of octanoic acid and decanoic acid with spinosyn-containing pesticides can enhance pesticidal efficacy observed in the field, as each of octanoic acid and decanoic acid in combination with spinosyns provide different degrees of synergistic efficacy for different pests. As an example, in some tested embodiments octanoic acid and decanoic acid were mixed with an octanoic:decanoic mixture ratio of about 2:3, although the present disclosure is not limited to such mixture constituents or ratios.

In some embodiments, the quantity of volatile base is proportional to the one or more aliphatic acids so as to bring the pH of the combined pesticidal composition (i.e. the pesticide, one or more aliphatic acids, volatile base, and optionally the adjuvant) to within the about the target pH range of the mixture. For example, in at least one embodiment where the pesticidal composition comprises Entrust®, which has a label range for pH of 6-9, the quantity of volatile base mixed with the one or more aliphatic acids is effective to increase the pH of at least one of: the combined base-acid mixture, the combined acid-base-adjuvant mixture, and/or the combined pesticidal composition to about 6 (e.g. in the range of 5-7).

In some embodiments, the one or more aliphatic acids, the volatile base, and the adjuvant are mixed to form a homogeneous mixture wherein the one or more aliphatic acids comprise about 20 to 50 wt %, the volatile base comprises 10 to 30 wt %, and the adjuvant comprises 40 to 60 wt %. For example, a variety of embodiments comprising Entrust® as a pesticidal composition, LI-700® as an adjuvant, ammonium hydroxide as the base, and a mixture of octanoic and decanoic acid (in a 2:3 w/w octanoic:decanoic mixture ratio) have been tested experimentally within these ranges, as described in greater detail below. Mixture ratios of one or more aliphatic acids to adjuvant to pesticidal composition of 25:50:16, 3:5:2, 25:25:12, and 25:25:18, when diluted with water to 0.215 wt %, provided homogeneous mixtures with pH in a range from 5.35 to 8.1.

The foregoing compositions may comprise a diluent as appropriate, e.g. to reduce the concentration of an adjuvant to within the range stated on the label or any other desired range. For instance, in an application of LI-700® where a target rate of 1250 ppm is within the range stated by the label, a mixture comprising 12.5 g of LI-700® with some quantity of one or more aliphatic acids and volatile base may be mixed with distilled water (or any other suitable diluent) in a quantity sufficient to achieve about the target 1250 ppm LI-700® rate. Some embodiments are shelf-stable and/or homogeneous prior to mixture with a diluent, whereas some embodiments are unstable (e.g. foaming, prone to separation after a short time) prior to mixture with a diluent but shelf-stable and/or homogeneous after mixture with a suitable quantity of diluent.

### Other Formulation Ingredients

In some embodiments, when the pesticidal compositions disclosed in this disclosure comprise and/or are used in a formulation, such formulation may also contain other constituents. These constituents include, but are not limited to, wetters, spreaders, stickers, penetrants, buffers, sequestering agents, drift reduction agents, compatibility agents, anti-foam agents, cleaning agents, rheology modifying agents, stabilizers, dispersing agents, emulsifiers, surfactants, diluents, and/or carriers. Several exemplary such additional formulation components are described below.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulphate; sodium dioctyl sulphosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulphonates. For suspension concentrates, very good adsorption and stabilization are obtained using polyelectrolytes, such as sodium naphthalene sulphonate formaldehyde condensates. Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in agrochemical formulations are: sodium lignosulphonates; sodium naphthalene sulphonate formaldehyde condensates; tristyrylphenol ethoxylate phosphate esters; aliphatic alcohol ethoxylates; alkyl ethoxylates; EO-PO block copolymers; and graft copolymers. Further examples of surfactants that can be used in some embodiments of the present disclosure include, but are not limited to sodium lauryl sulfate, saponin, ethoxylated alcohols, ethoxylated fatty esters, alkoxylated glycols, ethoxylated fatty acids, ethoxylated castor oil, glyceryl oleates, carboxylated alcohols, carboxylic acids, ethoxylated alkylphenols, fatty esters, sodium dodecylsulfide, other natural or synthetic surfactants, and combinations thereof. In some embodiments, the surfactant(s) are non-ionic surfactants. In some embodiments, the surfactant(s) are cationic or anionic surfactants. In some embodiments, a surfactant may comprise two or more surface active agents used in combination. The selection of an appropriate surfactant depends upon the relevant applications and conditions of use, and selection of appropriate surfactants are known to those skilled in the art.

An emulsifying agent is a substance which stabilizes a suspension of droplets of one liquid phase in another liquid phase. Without the emulsifying agent the two liquids would typically separate into two immiscible liquid phases. Exemplary commonly used emulsifier blends may contain alkylphenol or aliphatic alcohol with 12 or more ethylene oxide units and the oil-soluble calcium salt of dodecylbenzene sulphonic acid for example. In some embodiments, a range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. Exemplary types of surfactants usually used for solubilization include non-ionics: sorbitan monooleates; sorbitan monooleate ethoxylates; and methyl oleate esters.

Thickeners or gelling agents may be typically used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. In some examples, it is possible to produce suspension concentrate formulations using clays and silicas. Examples of these types of materials, include, but are not limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose. Examples of these types of materials include, but are not limited to, guar gum; locust bean gum; carrageenam; alginates; methyl cellulose; sodium carboxymethyl cellulose (SCMC); hydroxyethyl cellulose (HEC). Other types of anti-settling agents are based on modified starches, polyacrylates, polyvinyl alcohol, polyethylene oxide and xanthan gum.

The presence of surfactants, which lower interfacial tension, often causes water-based formulations to foam during mixing operations in production and in application of a pesticidal composition through a spray tank. In order to reduce the tendency to foam, anti-foam agents are often added either during the production stage or before filling into bottles. Generally, there are two types of anti-foam agents, namely silicones and non-silicones. Silicones may usually comprise aqueous emulsions of dimethyl polysiloxane while the non-silicone anti-foam agents comprise water-insoluble oils, such as octanol and nonanol, or silica. In both cases, the function of the anti-foam agent is to displace the surfactant from the air-water interface.

In some embodiments such formulations may comprise one or more suitable carrier or diluent components. A suitable carrier or diluent component can be selected by one skilled in the art, depending on the particular application desired and the conditions of use of the composition. Commonly used carriers and diluents may include ethanol, isopropanol, isopropyl myristate, other alcohols, water and other inert carriers, such as but not limited to those listed by the EPA as a Minimal Risk Inert Pesticide Ingredients (4A) (the list of ingredients published dated December 2015 by the US EPA FIFRA 4a list published August 2004 entitled “List 4A-Minimal Risk Inert Ingredients”) or, for example, Inert Pesticide Ingredients (4B) (the US EPA FIFRA 4b list published August 2004 entitled “List 4B—Other ingredients for which EPA has sufficient information”) or under EPA regulation 40 CFR 180.950 dated May 24, 2002, each of which is hereby incorporated herein in its entirety for all purposes including for example, citric acid, lactic acid, glycerol, castor oil, benzoic acid, carbonic acid, ethoxylated alcohols, ethoxylated amides, glycerides, benzene, butanol, 1-propanol, hexanol, other alcohols, dimethyl ether, and polyethylene glycol.

For further information on suitable such other formulation components known to those of skill in the art, reference may be made to publications such as, for example: “CHEMISTRY AND TECHNOLOGY OF AGROCHEMICAL FORMULATIONS” edited by D. A. Knowles, copyright 1998 by Kluwer Academic Publishers; and/or: “INSECTICIDES IN AGRICULTURE AND ENVIRONMENT—RETROSPECTS AND PROSPECTS” by A. S. Perry, I. Yamamoto, I. Ishaaya, and R. Perry, copyright 1998 by Springer-Verlag.

Methods for Making Compositions for Combination with Pesticidal Compositions

Aspects of the present disclosure comprise methods for making and/or enhancing pesticidal compositions. The pesticidal composition may comprise, for example, a fungicide, nematicide, insecticide, and/or other type of pesticide. In some aspects, the methods involve mixing one or more aliphatic acids and a volatile base to form a salt. The salt is at least one of soluble and emulsifiable with at least one of the pesticidal composition and an adjuvant for the pesticidal composition. In some embodiments, the salt is mixed with the adjuvant, e.g. to form a “tank-mix” for combination with the pesticidal composition. In some embodiments, the salt is mixed with the pesticidal composition (with or without the adjuvant). The mixture ratios, pH ranges, ingredients, and other physical and chemical characteristics of the compositions made according to these methods are described in greater detail elsewhere herein.

The one or more aliphatic acids and the volatile base may be mixed together on their own or in the presence of the adjuvant, the pesticidal composition, and/or other composition (such as a diluent or carrier). In at least some embodiments, the one or more aliphatic acids and the volatile base are combined with the adjuvant. In some embodiments, the one or more aliphatic acids and the volatile base are combined with the adjuvant prior to combination with the pesticidal composition, e.g. to produce a shelf-stable and/or homogeneous mixture of the salt and adjuvant. Such combination may comprise, for example, mixing the one or more aliphatic acids with the volatile base to form a salt and mixing the salt with the adjuvant. As another example, such combination may comprise mixing the volatile base with the adjuvant to form a base-adjuvant mixture and mixing the one or more aliphatic acids with the base-adjuvant mixture (thereby causing the one or more aliphatic acids and the volatile base to neutralize in the presence of the adjuvant, forming a salt). As another example, such combination may comprise mixing the one or more aliphatic acids with the adjuvant to form an acid-adjuvant mixture and mixing the volatile acid with the base-adjuvant mixture (thereby forming a salt, as noted previously).

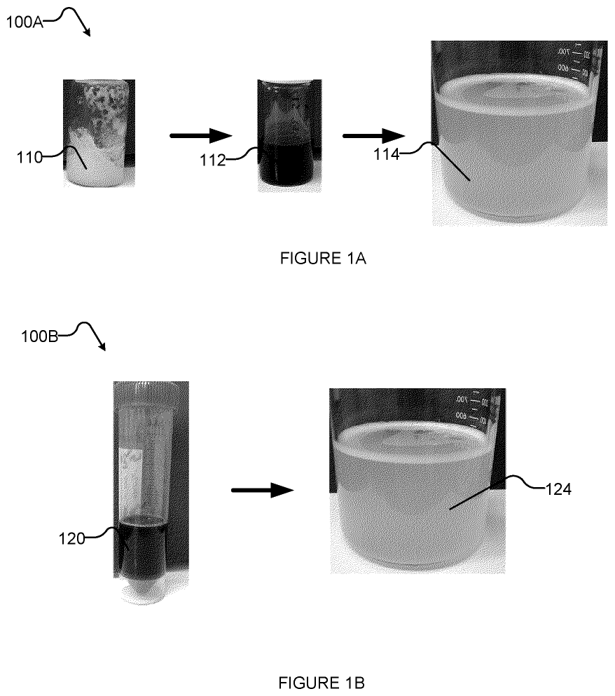

FIG. 1A shows an example preparation process 100a for preparing an example composition as described herein wherein the aliphatic acids and volatile base are mixed together to form a salt before combination with an adjuvant or pesticidal composition. The aliphatic acids (in the depicted embodiment, 5 g of a mixture of octanoic acid and decanoic acid in a 2:3 w/w mixture ratio) are mixed with the volatile base (in the depicted embodiment, 4 g of NH₄OH) to produce a salt 110 in solid form. The adjuvant is then mixed with the salt to produce mixture 112. Mixture 112 is homogeneous, stable, has a pH of approximately 5.7, and does not exhibit “crash-out” of the aliphatic acids, despite having a concentration of aliphatic acids above the natural precipitation threshold of LI-700®. Mixture 112 is then diluted into distilled water at a rate of 0.215% to produce diluted mixture 114. At this rate of dilution, diluted mixture 114 provides concentrations of 500 ppm for the aliphatic acids and 1250 ppm for the LI-700®. Diluted mixture 114 is homogeneous, stable, and does not exhibit crash-out, and may subsequently be mixed (e.g. as a tank mix) with a pesticidal composition, such as Entrust®.

In some embodiments, the one or more aliphatic acids and the volatile base are combined in the presence of the pesticidal composition. For example, such combination may comprise mixing the one or more aliphatic acids with the pesticidal composition to form an acid-pesticide composition and mixing the acid-pesticide composition with the base (optionally with the adjuvant, which may be mixed with the base or mixed with the pesticide separately, e.g. before, after, and/or in parallel with the mixing with the base). As another example, such combination may comprise mixing the volatile base with the pesticidal composition to form a base-pesticide composition and mixing the base-pesticide composition with the one or more aliphatic acids (optionally with the adjuvant, as noted previously).

FIG. 1B shows an example preparation process 100a for preparing an example composition as described herein wherein the aliphatic acids are mixed with an adjuvant before mixing with the volatile base to form a salt. The aliphatic acids (in the depicted embodiment, 5 g of a mixture of octanoic acid and decanoic acid in a 2:3 w/w mixture ratio) are added to a liquid adjuvant (in the depicted embodiment, 12.5 g of LI-700®) and mixed well, after which the volatile base (in the depicted embodiment, 4 g of NH₄OH) is added to the solution and mixed well to produce mixture 120. Mixture 120 is homogeneous, stable, has a pH of approximately 5.7, and does not exhibit “crash-out” of the aliphatic acids, despite having a concentration of aliphatic acids above the natural precipitation threshold of LI-700®. Mixture 120 is then diluted into distilled water at a rate of 0.215% to produce diluted mixture 124. At this rate of dilution, diluted mixture 124 provides concentrations of 500 ppm for the aliphatic acids and 1250 ppm for the LI-700®. Diluted mixture 124 is homogeneous, stable, and does not exhibit crash-out. Diluted mixture 124 may subsequently be mixed (e.g. as a tank mix) with a pesticidal composition, such as Entrust®.

Aspects of the present disclosure comprise methods for applying a pesticidal composition to control at least one pest. The method involves providing a pesticide mixed with a composition comprising one or more aliphatic acids and a volatile base as described herein (with or without an adjuvant and/or other ingredients); this is referred to herein as a “combined pesticidal composition.” The method further involves applying the combined pesticidal composition to at least one plant, the locus thereof, or propagation material thereof, which is susceptible to or infested with the at least one plant pest. After (and because of) applying the combined pesticidal composition (e.g. by spraying, fumigation, mechanical application, etc.), the volatile base will at least partially undergo volatilization and evaporate, thereby reconstituting the aliphatic acid. Such volatilization converts (at least some) of the one or more aliphatic acids from an anionic salt form to an acid form, thus restoring the bioactivity of the one or more aliphatic acids.

### Applications and Example Formulations

In some embodiments, the actual amount of a pesticidal composition to be applied to loci of pests may generally not be critical and can readily be determined by those skilled in the art through experience and/or trial and error in application rates, for example. In general, concentrations within a range of about 0.01 grams of pesticidal active ingredient per hectare to about 5000 grams of pesticidal active ingredient per hectare may commonly be used to establish a desired range of application rates expected to provide good control.

In some embodiments, a “tank-mix” formulation is provided for mixing with a target pesticidal composition. Such a formulation may comprise, for example, mixture of one or more aliphatic acids and a volatile base, optionally together with an adjuvant and/or a carrier or diluent miscible with the target pesticidal composition. For instance, such a formulation may comprise a mixture which is approximately 20 to 50 wt % aliphatic acid(s), 10 to 30 wt % volatile base, and 40 to 60 wt % adjuvant. The formulation may optionally be mixed with a diluent, emulsifier (such as an emulsifier described in U.S. Provisional Patent Application No. 62/787,175, incorporated herein by reference), or other suitable carrier miscible with the pesticidal composition and compatible with the aliphatic acid.

Such tank-mix formulations may be combined with suitable commercially-available target pesticidal compositions. For example, a tank-mix formulation comprising an aliphatic acid (such as one of the foregoing example formulations) may be combined with a commercially-available pesticidal composition compatible with the selected adjuvant. For instance, if the tank-mix formulation comprises LI-700®, the pesticidal composition may comprise Entrust® and/or another other pesticidal composition compatible with LI-700®. The tank-mix formulation may be added to the pesticidal composition (or vice versa) in sufficient quantity to provide a desired ratio of adjuvant to pesticidal composition, and the one or more aliphatic acids (e.g. octanoic acid, decanoic acid, and/or any other suitable acid described herein) may be added to the formulation to provide a desired ratio of one or more aliphatic acids to the pesticidal composition (e.g. so as to provide synergistic efficacy), subject to any limits on solubility of the aliphatic acid(s) in the tank-mix formulation (such limits being relaxed by the addition of the volatile base).

In some embodiments, one or more of the carrier, emulsifier, and aliphatic acid, and/or volatile base (as applicable) is at least one of: organic, certified organic, US Department of Agriculture (“USDA”) National Organic Program compliant (“NOP-compliant”) such as may be included in the US Environmental Protection Agency FIFRA 25b list of ingredients published dated December 2015 by the US EPA entitled “Active Ingredients Eligible for Minimum Risk Pesticide Products”, the US EPA FIFRA 4a list published August 2004 entitled “List 4A-Minimal Risk Inert Ingredients” or the US EPA FIFRA 4b list published August 2004 entitled “List 4B—Other ingredients for which EPA has sufficient information”, for example, Organic Materials Review Institute listed (“OMRI-listed”), or natural ingredient. The foregoing example formulations are examples of formulations where all ingredients may be NOP-compliant.

### EXAMPLES

Exemplary embodiments of the present invention are further described with reference to the following examples, which are intended to be illustrative and non-limiting in nature.

### Example 1: Octanoic Acid, Decanoic Acid, Ammonium Hydroxide, and LI-700®

Six exemplary compositions, each comprising different ratios of octanoic acid and decanoic acid, ammonium hydroxide, and LI-700® were prepared according to the following description. A mixture of octanoic acid and decanoic acid was prepared in a 2:3 w/w octanoic:decanoic mixture ratio. The mixture of acids was added to a testing vessel containing the adjuvant, LI-700®, and mixed well. The base, ammonium hydroxide, was subsequently added to the testing vessel and mixed well to form a stoke solution. The quantities of each ingredient used in each exemplary composition are set out in the table below. The stoke solution was observed visually four hours after mixing to assess stability. The stoke solution was then diluted into distilled water to produce a solution with 1250 ppm adjuvant (for compositions comprising 12.5 g of adjuvant) or 625 ppm adjuvant (for compositions comprising 6.25 g of adjuvant) and assessed for stability and pH.

TABLE 1

| | | | | Stoke | Dilution |
|---|---|---|---|---|---|
| Mixture | Acids | Adjuvant | Base | Stability | Stability |
| 1 | 5 g | 12.5 g | 4 g | Stable | Stable |
| | | | | | pH: 5.7 |
| 2 | 6.25 g | 12.5 g | 4 g | Stable | Stable |
| | | | | | pH: 5.35 |
| 3 | 7.5 g | 12.5 g | 5 g | Stable | Stable |
| | | | | | pH: 5.67 |
| 4 | 6.25 g | 6.25 g | 3 g | Foaming, | Stable |
| | | | | separation | pH: 5.47 |
| | | | | after 4 hours | |
| 5 | 6.25 g | 6.25 g | 4.5 g | Foaming but | Stable |
| | | | | stable | pH: 8.1 |
| 6 | 7.5 g | 6.25 g | 3 g | Phase | Crash out |
| | | | | separation, | pH: 5.36 |
| | | | | viscous | |

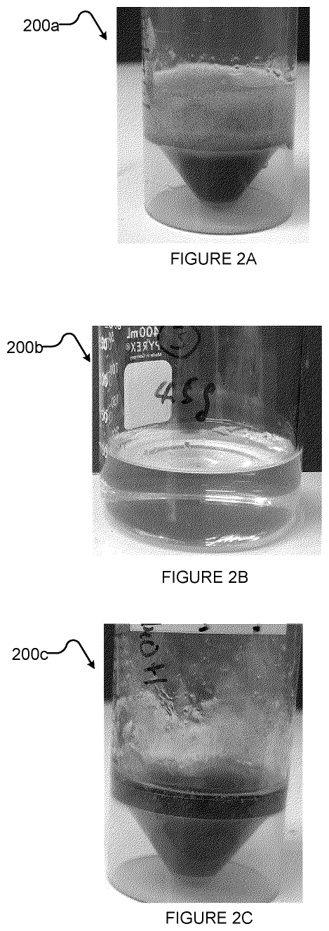

All mixtures except for mixture 6 provided stable dilution mixtures. Mixtures 1-5 have acid:adjuvant mixture ratios in a range of about 2:5 to 1:1, demonstrating that the addition of the volatile base allows for formulations which consistently exceed the observed natural precipitation threshold of about 2:5. Mixtures 1-3 in particular are stable in both stoke and dilution form and are thus potentially desirable for at least some applications. Various stages of mixture 1 are shown in FIG. 1B (mixture 120 is the stoke solution and diluted mixture 124 is the dilution). Mixtures 2 and 3 had broadly similar appearances. Mixtures 4 and 5 exhibited foaming in the stoke solution; the foaming of mixture 4 is shown in FIG. 2A. Mixture 5 provided a particularly stable and clear dilution mixture, shown in FIG. 2B. Mixture 6 was unstable; the stoke solution exhibited phase separation and was very viscous (perhaps due to the proportionately greater quantity of ammonium salt formed with the aliphatic acids), and the dilution mixture crashed out, as shown in FIG. 2C.

Of the foregoing mixtures, mixtures 1-4 and 6 provide acidic pH in a range of 5.35 to 5.7; i.e. of about 5-6. This range is generally suitable for promoting synergistic efficacy, when such exists, between the one or more aliphatic acids and pesticidal compositions such as Entrust®. It may, depending on the particular application, be suitable for combination with pesticidal compositions (and/or other compositions) which have a label rate which overlaps with a pH range of 5-6 and/or which is near to a pH range of 5-6. Entrust®, for example, has a pH label range of 6-9 and when combined with any of these example dilution mixtures is expected to have a pH of about 5-6. Although this is outside of the label range of Entrust®, it is a great deal nearer to the label range than would be provided in the absence of the volatile base and will in at least some (and perhaps most) cases provide pesticidal efficacy. Indeed, the pH of each of mixtures 1-4 and 6, in dilution, is similar to that of LI-700® when diluted for combination with Entrust®, so the overall acidity of the combined pesticidal composition is within the label range for the adjuvant. The volatile base has thus compensated for the acidification caused by the aliphatic acids while also increasing their solubility in the adjuvant, while limiting the loss of bioactivity of the aliphatic acids post-application. (For applications requiring a basic—or less acidic—pH, mixture 5 may be suitable.)

### CONCLUDING GENERALITIES

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method for making a composition for combination with a pesticidal composition including at least one pesticidal active ingredient, the method comprising:
mixing one or more aliphatic acids and a volatile base to form a salt thereof, the salt at least one of soluble and emulsifiable with at least one of the pesticidal composition and an adjuvant for the pesticidal composition to form a combined pesticidal composition.

2. A method according to claim 1 comprising mixing the adjuvant for the pesticidal composition with at least one of the one or more aliphatic acids and the volatile base.

3. A method according to claim 2 wherein mixing the adjuvant for the pesticidal composition with at least one of the one or more aliphatic acids and the volatile base comprises mixing the one or more aliphatic acids, the volatile base, and the adjuvant to form a homogeneous mixture of:
the one or more aliphatic acids comprising about 20 to 50 wt %;
the volatile base comprising about 10 to 30 wt %; and
the adjuvant comprising about 40 to 60 wt %.

4. A method according to claim 2 comprising mixing the one or more aliphatic acids, the volatile base, and the adjuvant with the pesticidal composition to form the combined pesticidal composition.

5. A method according to claim 4 wherein the salt is at least one of soluble and emulsifiable with the adjuvant to form a salt-adjuvant composition and mixing the one or more aliphatic acids, the volatile base, and the adjuvant with the pesticidal composition comprises mixing the adjuvant with the salt to form a salt-adjuvant composition; and the method comprises mixing the salt-adjuvant composition with the pesticidal composition to form the combined pesticidal composition.

6. A method according to claim 4 wherein mixing the one or more aliphatic acids, the volatile base, and the adjuvant with the pesticidal composition comprises mixing the volatile base with the adjuvant to form a base-adjuvant composition and mixing the one or more aliphatic acids with the base-adjuvant composition, the pesticidal composition, and/or a mixture thereof.

7. A method according to claim 2 wherein mixing the adjuvant with the at least one of the one or more aliphatic acids and the volatile base comprises mixing the adjuvant with the one or more aliphatic acids with a mixture ratio of one or more aliphatic acids to adjuvant of at least about 2:5 w/w; optionally wherein mixing the adjuvant with the at least one of the one or more aliphatic acids and the volatile base comprises mixing the adjuvant with the one or more aliphatic acids with a mixture ratio of one or more aliphatic acids to adjuvant of at most about 1:1 w/w.

8. (canceled)

9. A method according to claim 2 wherein mixing the one or more aliphatic acids with the volatile base comprises mixing the one or more aliphatic acids with the volatile base with a mixture ratio of one or more aliphatic acids to volatile base in a range of about 25:18 to 25:12.

10. A method according to claim 7 wherein the adjuvant comprises a liquid fatty acid and the liquid fatty acid comprises 10 to 100 wt % of the adjuvant.

11. A method according to claim 10 wherein the liquid fatty acid comprises propionic acid and the propionic acid comprises 30 to 40 wt % of the adjuvant.

12. A method according to claim 7 wherein the adjuvant comprises a phospholipid and the phospholipid comprises 10 to 100 wt % of the adjuvant; optionally wherein the phospholipid comprises a soyal phospholipid and the soyal phospholipid comprises 30 to 40 wt % of the adjuvant.

13. (canceled)

14. A method according to claim 7 wherein the adjuvant has a pH in a range of about 1 to 6, optionally wherein the adjuvant has a pH in a range of about 3 to 4.

15. (canceled)

16. A method according to claim 1 wherein the one or more aliphatic acids comprises a saturated or unsaturated fatty acid, wherein optionally the fatty acid has a carbon chain length no greater than 12; wherein the fatty acid comprises at least one of: a trans-unsaturated C—C bond, a cis-unsaturated C—C bond, and a plurality of conjugated unsaturated C—C bonds; wherein the fatty acid comprises at least one of: a trans-2, trans-3, trans-4, trans-5, trans-6, trans-7, trans-8, trans-9, trans-10, trans-11, cis-2, cis-3, cis-4, cis-5, cis-6, cis-7, cis-8, and cis-9, cis-10, and cis-11 unsaturated bond; or wherein the fatty acid comprises at least one of a trans-hexenoic acid, a cis-hexenoic acid, a hexa-dienoic acid, a hexynoic acid, a trans-heptenoic acid, a cis-heptenoic acid, a hepta-dienoic acid, a heptynoic acid, a trans-octenoic acid, a cis-octenoic acid, an octa-dienoic acid, an octynoic acid, a trans-nonenoic acid, a cis-nonenoic acid, a nona-dienoic acid, a nonynoic acid, a trans-decenoic acid, a cis-decenoic acid, a deca-dienoic acid, a decynoic acid, a trans-dodecenoic acid, a cis-dodecenoic acid, a dodeca-dienoic acid, a dodecynoic acid, hexanoic acid, heptanoic acid, octanoic acid, nonanoic acid, decanoic acid, and dodecanoic acid.

17. (canceled)

18. (canceled)

19. (canceled)

20. (canceled)

21. A method according to claim 16 wherein the fatty acid is selected from the group consisting of: octanoic acid and decanoic acid; optionally wherein the one or more aliphatic acids comprise a mixture of octanoic acid and decanoic acid.

22. (canceled)

23. A method according to claim 1 wherein the volatile base comprises at least one of: ammonium hydroxide and trimethylamine.

24. A method according to claim 1 wherein the pesticidal composition has an effective pH range, an acid-pesticide mixture of the one or more aliphatic acids and the pesticidal composition would have a pH outside the effective pH range, and the volatile base is effective to increase the pH of the acid-pesticide mixture to within about the effective pH range;
or wherein:
an adjuvant-pesticide mixture of the pesticidal composition and the adjuvant would have an effective pH range, an acid-adjuvant-pesticide mixture of the one or more aliphatic acids and the adjuvant-pesticide mixture would have a pH outside the effective pH range, and the volatile base is effective to increase the pH of the acid-adjuvant-pesticide mixture to within about the effective pH range.

25. (canceled)

26. A method according to claim 24 wherein the volatile base is effective to increase the pH of the acid-adjuvant-pesticide mixture to at least about 5; or wherein the pesticidal composition has a label pH range with a minimum value of about 6.

27. A method according to claim 24 wherein the pesticidal active ingredient comprises a spinosyn compound.

28. (canceled)

29. A method for applying a pesticidal composition to control at least one plant pest, comprising:
making a combined pesticidal composition comprising an aliphatic acid, a volatile base, and a pesticidal composition, making the combined pesticidal composition comprising making a composition for combination with the pesticidal composition according to claim 1;
applying the combined pesticidal composition to at least one plant, the locus thereof, or propagation material thereof, which is susceptible to or infested with the at least one plant pest; and
causing, by the applying, the volatile base to evaporate, thereby reconstituting the aliphatic acid on the at least one plant, the locus thereof, or propagation material thereof.

30. A composition for combination with a pesticidal composition including at least one pesticidal active ingredient, the composition comprising:
one or more aliphatic acids;
a volatile base;
wherein the one or more aliphatic acids and the volatile base are neutralizable to form a salt, the salt at least one of soluble and emulsifiable with at least one of the pesticidal composition and an adjuvant for the pesticidal composition to form a combined pesticidal composition;
optionally wherein the composition comprises a homogeneous mixture of the salt and the adjuvant; or
optionally wherein the composition comprises a homogeneous mixture of the salt, the adjuvant, and pesticidal composition.

31.-55. (canceled)
